(19) United States
(12) Patent Application Publication
(10) Pub. No.: US 2024/0046417 A1
(43) Pub. Date: Feb. 8, 2024

(54) IMAGE PROCESSING DEVICE, IMAGE PROCESSING METHOD, AND IMAGE PROCESSING PROGRAM

(71) Applicant: HITACHI, LTD., Chiyoda-ku, Tokyo (JP)

(72) Inventors: Kumiko KONISHI, Tokyo (JP); Akio YONEYAMA, Tokyo (JP); Hiroyuki OKINO, Tokyo (JP)

(21) Appl. No.: 18/035,990

(22) PCT Filed: Sep. 3, 2021
(86) PCT No.: PCT/JP2021/032538

§ 371 Date: May 9, 2023

(30) Foreign Application Priority Data
Nov. 20, 2020 (JP) 2020-193844

(51) Int. Cl. G06T 5/20; G06T 5/00; G06T 5/40; G06T 5/50; G06T 7/00; G06V 10/60

(52) U.S. Cl. CPC G06T 5/20; G06T 5/002; G06T 5/40; G06T 5/50; G06T 7/0008; G06V 10/60; G06T 2207/20221; G06T 2207/30148

(57) ABSTRACT

An image processing device for removing a noise having directionality in a first direction from an image containing the noise without affecting information on minute shading of luminance of the image, including: a high-pass filter unit configured to perform filtering processing on an image containing a noise having directionality in a horizontal direction with a high-pass filter in the horizontal direction; a low-pass filter unit configured to perform filtering processing on the image in a vertical direction with a low-pass filter; and an addition unit configured to add an image processed by the high-pass filter unit and an image processed by the low-pass filter unit.

### TECHNICAL FIELD

The present invention relates to an image processing device, an image processing method, and an image processing program for removing a noise having directionality.

### BACKGROUND ART

In an image obtained by line-scanning an object to be measured, a noise having directionality in a main scanning direction or a sub-scanning direction frequently occurs. In order to detect, for example, a defect density distribution based on minute shading of luminance in the image, it is necessary to remove the noise having directionality.

### CITATION LIST

### Patent Literature

PTL 1: JP2003-280455A

### SUMMARY OF INVENTION

### Technical Problem

PTL 1 discloses a method of removing a noise having directionality. PTL 1 discloses that, for a target pixel of pixel information, an average value of a predetermined region through the target pixel in a noise occurrence direction is calculated, and a value obtained by subtracting the average value from a target pixel value is set as a value of the target pixel. However, in this method, the average value is subtracted, causing a difference from a true value. Since information (noise pitch or the like) unique to a device is not utilized, the device may not operate properly. Thus, in this method, minute shading of luminance cannot be detected from the noise having directionality.

Therefore, an object of the invention is to provide an image processing device, an image processing method, and a program to remove a noise having directionality in a first direction from an image containing the noise without affecting information on minute shading of luminance of the image.

### Solution to Problem

In order to solve the above problems, an image processing device according to the invention includes: a high-pass filter unit configured to perform filtering processing on an image containing a noise having directionality in a first direction with a high-pass filter in the first direction; a low-pass filter unit configured to perform filtering processing on the image in a second direction perpendicular to the first direction with a low-pass filter; and an addition unit configured to add an image processed by the high-pass filter unit and an image processed by the low-pass filter unit.

An image processing method according to the invention includes: executing a step of calculating an image filtered individually with a high-pass filter in a first direction for each image containing a noise having directionality in the first direction; executing a step of calculating an image filtered with a low-pass filter in a second direction perpendicular to the first direction; and executing a step of adding an image filtered with the high-pass filter and an image filtered with the low-pass filter.

An image processing program according to the invention causes a computer to execute a procedure of performing filtering processing on an image containing a noise having directionality in a first direction with a high-pass filter in the first direction, a procedure of performing filtering processing on the image in a second direction perpendicular to the first direction with a low-pass filter, and a procedure of adding an image filtered with the high-pass filter and an image filtered with the low-pass filter. Other units will be described in embodiments for carrying out the invention.

### Advantageous Effects of Invention

According to the invention, it is possible to remove a noise having directionality in a first direction from an image containing the noise without affecting information on minute shading of luminance of the image.

### BRIEF DESCRIPTION OF DRAWINGS

FIG. 1 is a configuration diagram of an image processing device according to the present embodiment.

FIG. 2 is a logical block diagram of the image processing device.

FIG. 3 is a diagram showing a wafer image containing a noise in a horizontal direction.

FIG. 4 is a conceptual diagram of defects in a region of the wafer image.

FIG. 5 is a diagram showing an operation of an X-ray imaging device.

FIG. 6 is a graph showing pixel luminance along a horizontal direction of the wafer image.

FIG. 7 is a graph showing pixel luminance along a vertical direction of the wafer image.

FIG. 8 is a graph showing spatial frequency characteristics of pixel luminance in the horizontal direction of the wafer image.

FIG. 9 is a diagram showing spatial frequency characteristics of pixel luminance in the horizontal direction after filter processing.

FIG. 10 is a graph showing pixel luminance along the horizontal direction of an image obtained by inverse FFT after high-pass filter processing at each cut off frequency.

FIG. 11 is a graph showing pixel luminance along the vertical direction of an image obtained by inverse FFT after high-pass filter processing at each cut off frequency.

FIG. 12 is a graph showing dependence of filter characteristics on cut off frequency.

FIG. 13 is a graph showing dependence of filter characteristics on a cut off degree.

FIG. 14 is a flowchart showing noise removal processing.

FIG. 15 is a diagram showing an example of each region cut out from a noise-removed image and defect density thereof.

FIG. 16 is a diagram showing a histogram of pixel luminance in each region cut out from the noise-removed image.

FIG. 17A is a flowchart of estimating the defect density from the noise-removed image.

FIG. 17B is a flowchart of estimating the defect density from the noise-removed image.

### DESCRIPTION OF EMBODIMENTS

Hereinafter, an embodiment of the invention will be described in detail with reference to the drawings.

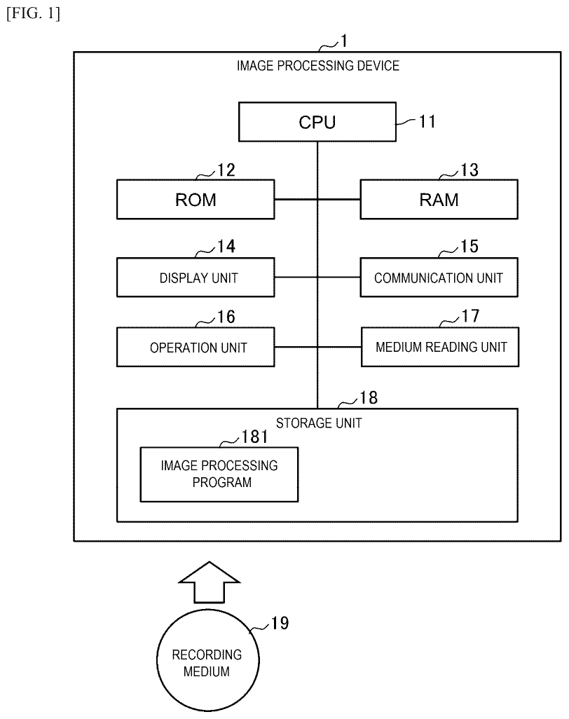

FIG. 1 is a configuration diagram of an image processing device 1 according to the present embodiment.

The image processing device 1 is a computer including a central processing unit (CPU) 11, a read only memory (ROM) 12, and a random access memory (RAM) 13.

The CPU 11 is a central processing unit, and executes programs stored in the ROM 12, a storage unit 18, and the like. The ROM 12 is a non-volatile memory and implements basic input and output of the computer. The RAM 13 is a volatile memory, and is used as a variable storage area when the CPU 11 executes a program.

The image processing device 1 further includes a display unit 14, a communication unit 15, an operation unit 16, a medium reading unit 17, and the storage unit 18.

The display unit 14 is, for example, a liquid crystal display, and displays characters, graphics, images, and the like.

The communication unit 15 is, for example, a network interface card (NIC), and transmits and receives information to and from an external device.

The operation unit 16 is, for example, a keyboard or a mouse, and is used by an operator to operate this image processing device 1.

The medium reading unit 17 reads an external recording medium 19 or the like, and is, for example, an optical drive. The external recording medium 19 stores, for example, an image processing program 181 and an installer thereof.

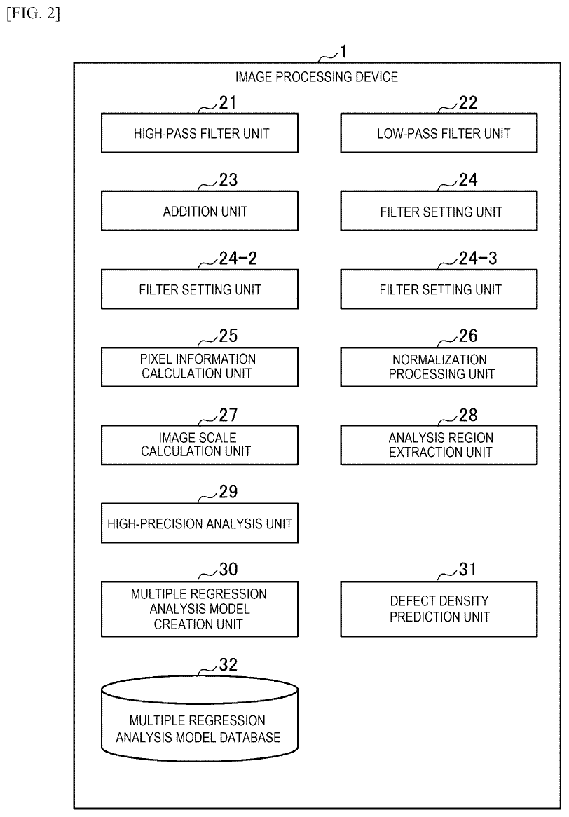

The storage unit 18 is a large-capacity storage device such as a hard disk drive or a solid state drive (SSD). The image processing program 181 is stored in the storage unit 18. By executing the image processing program 181 by the CPU 11, each unit shown in FIG. 2, which will be described later, is embodied and predetermined image processing is executed.

FIG. 2 is a logical block diagram of the image processing device 1.

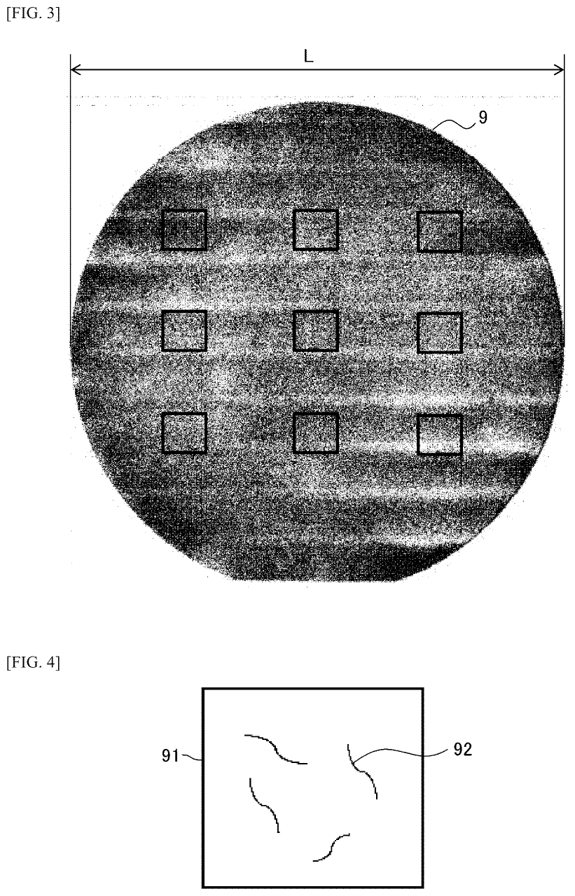

The image processing device 1 includes, as logical blocks, a high-pass filter unit 21, a low-pass filter unit 22, an addition unit 23, and filter setting units 24, 24-2, and 24-3. A noise can be removed from a scanned image of a wafer 9 shown in FIG. 3 by an operation of each unit.

The high-pass filter unit 21 performs filtering processing in a horizontal direction (first direction) of an input image with a high-pass filter. The processing of the high-pass filter unit 21 is defined by the following formula (1).

$$\begin{matrix}[ Formula 1 ] & \\ {τ}_{h} = 1 - α {e}^{\frac{- f}{{f}_{c}} \times δ} & ( 1 )\end{matrix}$$

in which
τₕ: transmittance of high-pass filter
α: strength of filter
f: spatial frequency
f_{c}: cut off frequency
δ: cut off degree

The low-pass filter unit 22 performs filtering processing in a vertical direction (second direction) of an input image with a low-pass filter. The processing of the low-pass filter unit 22 is defined by the following formula (2).

$$\begin{matrix}[ Formula 2 ] & \\ {τ}_{l} = α {e}^{\frac{- f}{{f}_{c}} \times δ} & ( 2 )\end{matrix}$$

τ₁: transmittance of low-pass filter

A sum of transmittance at each spatial frequency of the high-pass filter unit 21 and transmittance at each spatial frequency of the low-pass filter unit 22 is 1.

The filter setting unit 24 sets cut off frequency or a cut off period for the high-pass filter unit 21 and the low-pass filter unit 22. The filter setting unit 24 changes the cut off frequency or the cut off period for the low-pass filter unit 22 and the high-pass filter unit 21 according to a period of a noise in an image having directionality in the horizontal direction.

The filter setting unit 24-2 sets a cut off degree for the high-pass filter unit 21 and the low-pass filter unit 22. The filter setting unit 24-2 changes the cut off degree for the low-pass filter unit 22 and the high-pass filter unit 21 according to a degree of a noise in an image having directionality in the horizontal direction.

The filter setting unit 24-3 sets strength of filters in the high-pass filter unit 21 and the low-pass filter unit 22. The filter setting unit 24-3 changes strength of the filters in the low-pass filter unit 22 and the high-pass filter unit 21 according to a degree of a noise of an image having directionality in the horizontal direction.

The addition unit 23 adds an image subjected to a high-pass filter in the horizontal direction and an image subjected to a low-pass filter in the vertical direction. This makes it possible to remove a noise having directionality in the horizontal direction from an image containing the noise without affecting information on minute shading of luminance of the image.

The image processing device 1 further includes a pixel information calculation unit 25, a normalization processing unit 26, an image scale calculation unit 27, an analysis region extraction unit 28, a high-precision analysis unit 29, a multiple regression analysis model creation unit 30, a defect density prediction unit 31, and a multiple regression analysis model database 32.

The pixel information calculation unit 25 extracts pixel information from a region of an image. The pixel information includes a height, an average value, a median value, a standard deviation, and the like of a luminance histogram.

The normalization processing unit 26 normalizes luminance in an image of a wafer, which is a subject of the image, in order to compare different wafers.

The image scale calculation unit 27 calculates an image scale. By using the image scale, the analysis region extraction unit 28 can specify a position and size of a wafer captured in the image.

The analysis region extraction unit 28 specifies a position and size of a wafer captured in an image from the image of the wafer, and further extracts an analysis region.

The high-precision analysis unit 29 analyzes the extracted analysis region with high precision and calculates defect density.

The multiple regression analysis model creation unit 30 creates a model for multiple regression analysis in which the pixel information of each region (including the height, the average value, the median value, the standard deviation, and the like of the luminance histogram) is set as an explanatory variable and the defect density obtained by the high-precision analysis of each region is set as an objective variable, and stores the model in the multiple regression analysis model database 32.

The defect density prediction unit 31 predicts a distribution of the defect density as the objective variable based on the model in the multiple regression analysis model database 32 and the pixel information as the explanatory variable.

### <<Defect Density Distribution in SiC Wafer>>

Since in-plane defect density of a SiC wafer is an important index which affects a manufacturing yield of a device formed thereon, it is necessary to grasp an in-plane defect density distribution of the wafer. At present, the image processing device evaluates the in-plane defect density of the SiC wafer by X-ray topography method (XRT).

In order to acquire a high-precision image with a level at which the defect density can be analyzed, an enormous amount of time is required, which is not realistic. Thus, it is desirable to use a method of performing a high-precision analysis in a limited region after a quick view of a wafer plane with coarse precision.

FIG. 3 is a diagram showing an image obtained by X-ray imaging a plane of the wafer 9 with coarse precision.

The wafer 9 has a disk shape and has a diameter L [Pixel]. Nine rectangles shown in the image of the wafer 9 indicate regions 91 to be analyzed with high precision.

FIG. 4 is a conceptual diagram of a region 91 of the wafer 9 and a defect 92 in the region 91.

In a procedure of performing quickly view of the plane of the wafer 9 with coarse precision, defect density cannot be extracted. In contrast, a procedure of limiting the region in the plane of the wafer 9 and analyzing the region with high precision can extract numerical information on the defect density in the limited region.

The inventors propose that a region to be analyzed with high precision is cut out from an image of the plane of the wafer 9 with coarse precision, pixel information thereof (an average, a median value, a histogram shape, and the like of pixels) is acquired, and a model for multiple regression analysis is created in which the pixel information on the analysis region is used as the explanatory variable and a defect density obtained by the analysis with high precision is used as the objective function. The inventors propose to use the model for the multiple regression analysis to calculate a defect density distribution based on the pixel information in the image of the plane of the wafer 9 with coarse precision. Accordingly, the distribution of the in-plane defect density of the wafer 9 can be grasped by the evaluation in a short time.

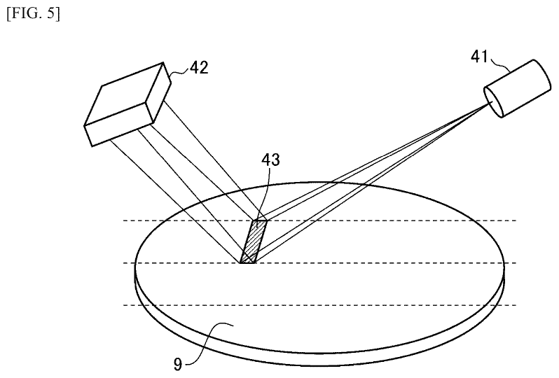

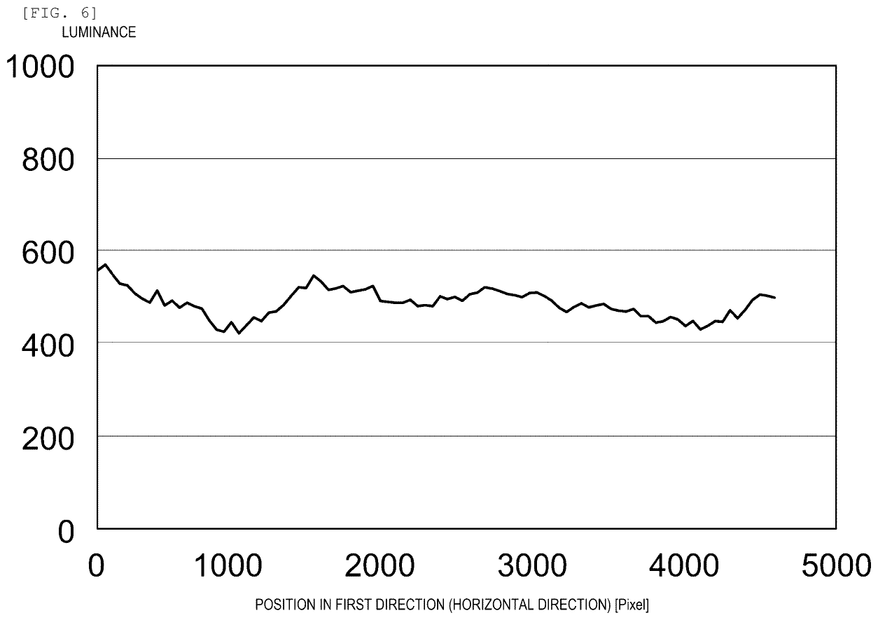

FIG. 5 is a diagram showing a defect evaluation method when the wafer plane is quickly viewed with coarse precision with an X-ray imaging device.

The X-ray imaging device (not shown) performs scanning in a right direction (main scanning direction) of the drawing by an actuator (not shown) while irradiating the plane of the wafer 9 with an X-ray from an X-ray light source 41. An X-ray irradiation region 43 in which the plane of the wafer 9 is irradiated with the X-ray light source 41 has a rectangular shape. The X-ray irradiation region 43 may have a square shape. By detecting the X-ray irradiation region 43 by a two-dimensional detector 42, the wafer 9 is line-scanned. The region obtained by one line scanning is a region divided by broken lines in the drawing.

When the X-ray irradiation region 43 reaches one end of the scan region, the X-ray imaging device moves the X-ray light source 41 to a far side (sub-scanning direction) of the drawing (step), and then performs line scanning in a left direction of the drawing, and repeats this. Accordingly, an image obtained by scanning the wafer 9 in a line and combining line scan images is obtained as data.

However, the entire image obtained by combining line scan images by the X-ray imaging device has a horizontal stripe noise in the main scanning direction. Finally, it is desired to extract a distribution of a defect density from information on minute shading of luminance in the image, but an accurate value cannot be acquired unless the horizontal stripe noise is removed.

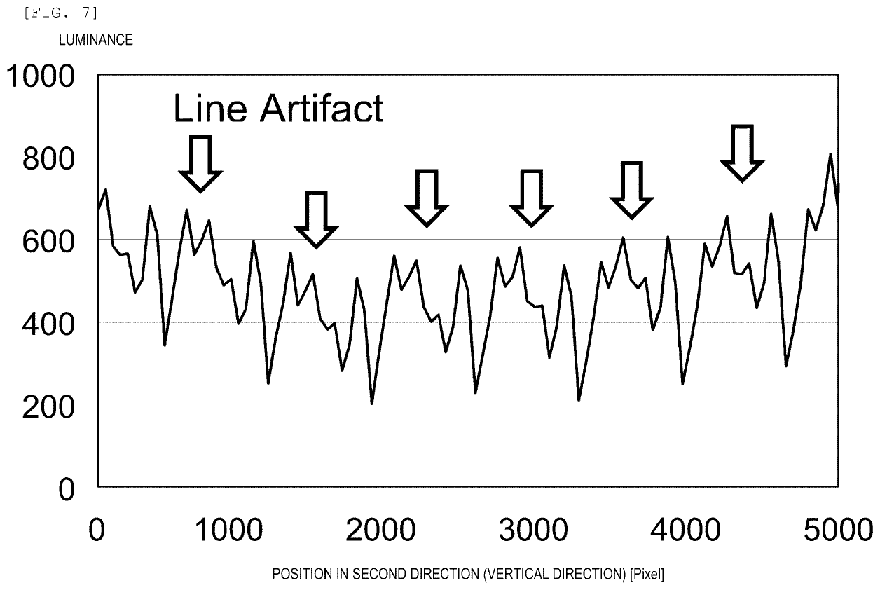

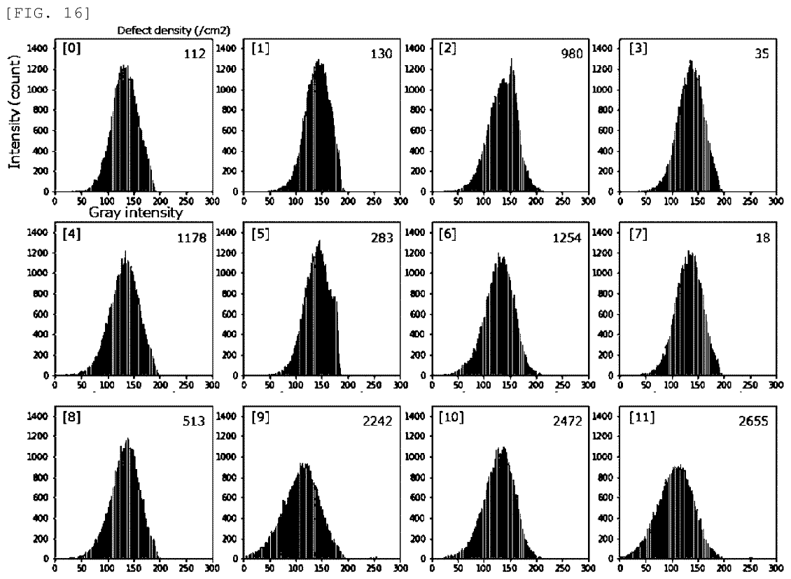

Therefore, a method of effectively removing a noise having directionality from an image of the wafer 9 without affecting the information on the minute shading of the luminance in the image will be described with reference to FIGS. 6 to 14. A method of predicting the defect density distribution based on the information on the minute shading of the luminance in the image will be described below with reference to FIGS. 15 to 17A and 17B.

### <<Method of Removing Noise Having Directionality>>

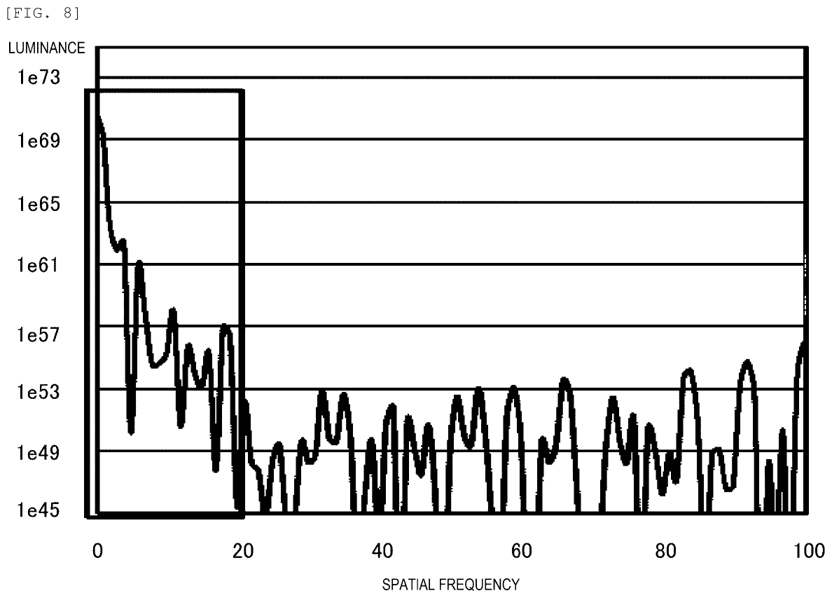

FIG. 6 is a graph in which pixel luminance along the horizontal direction (first direction) in an image is converted into two dimensions. FIG. 7 is a graph in which pixel luminance along the vertical direction (second direction) in an image is converted into two dimensions. Vertical axes in the graphs of FIGS. 6 and 7 indicate the pixel luminance linearly. Horizontal axes in the graphs of FIGS. 6 and 7 indicate a position of a wafer.

As shown in FIG. 7, when the image processing device 1 converts the pixel luminance along the vertical direction (second direction) in the image into two dimensions, a horizontal stripe noise appears. In FIG. 7, the horizontal stripe noise occurs at a position indicated by an arrow with line artifact.

This occurs in an image obtained by combining observation images obtained by repeating line scanning and steps. The horizontal stripe noise occurs due to complex causes such as an illuminance distribution of X-rays, an intensity distribution of diffracted X-rays, and a sensitivity distribution of a charge-coupled device (CCD) on a light-receiving side of the detector 42. When the horizontal stripe noise is present, it is extremely difficult for the image processing device 1 to extract the defect density distribution as numerical information based on an in-plane minute contrast shading.

This horizontal strip noise is caused by a difference in offsets superimposed in the horizontal direction. There are the following two methods of removing the horizontal stripe noise.

A first method is a method of performing fast Fourier transform (FFT) on a luminance distribution in a vertical direction of an image to obtain spatial frequency characteristics, performing filtering processing by a band-pass filter obtained based on a period of a horizontal stripe noise, and performing inverse FFT to reconstruct the image. In the first method, when the period of the horizontal stripe noise is changed, an original band-pass filter cannot be applied. That is, it is necessary to design the band-pass filter each time depending on measurement conditions, which is not practical. Further, due to a problem of periodicity in Fourier transform, when luminance at both ends is discontinuous, a new artifact occurs.

A second method is a method of performing FFT on a luminance distribution in a horizontal direction of an image to obtain spatial frequency characteristics, performing filtering processing with a high-pass filter excluding a low-frequency region serving as an offset component, and performing inverse FFT to reconstruct the image. In the second method, the same high-pass filter can be used even when the period of the horizontal stripe noise is slightly changed. The invention removes the horizontal stripe noise by the second method.

FIG. 8 is a graph showing spatial frequency characteristics of pixel luminance in the horizontal direction. A vertical axis of the graph indicates a signal intensity in logarithm. A horizontal axis of the graph indicates spatial frequency. Here, the spatial frequency refers to the number of periodic structures (the number of waves) in the diameter L [Pixel] of the wafer.

FIG. 8 shows a relationship between a power spectrum and a spatial frequency obtained by performing FFT on pixel luminance distribution along the horizontal direction (first direction) in the image. From this, it can be seen that a signal data range. This portion is an offset superimposed in the horizontal direction, which causes a horizontal stripe noise.

Thus, the image processing device 1 performs multiplication by the high-pass filter intensity is considerably greater in low-frequency components up to spatial frequency 20 as compared with an actual in the first direction (horizontal) to remove a noise which is a low-frequency component. Accordingly, the horizontal stripe noise can be removed. The high-pass filter preferably has cut off frequency of 5 to 20. In other words, it is preferable to set a cut off period to ⅕ to 1/20 of the wafer diameter L [Pixel], that is, L/5 to L/20 [Pixel].

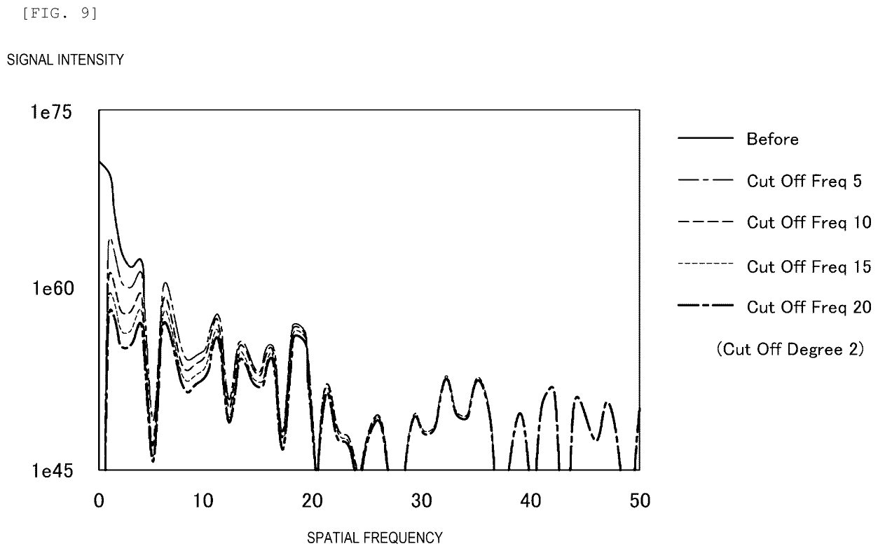

FIG. 9 is a graph showing spatial frequency characteristics of pixel luminance in the horizontal direction after filter processing. A vertical axis of the graph indicates a signal intensity in logarithm after the filter processing. A horizontal axis of the graph indicates spatial frequency.

It can be seen that low-frequency components are reduced by subjecting the image of the wafer 9 to FFT on the pixel luminance distribution along the horizontal direction (first direction) and performing filtering processing with the high-pass filter. As the cut off frequency of the high-pass filter increases, frequency components up to higher frequencies can be reduced.

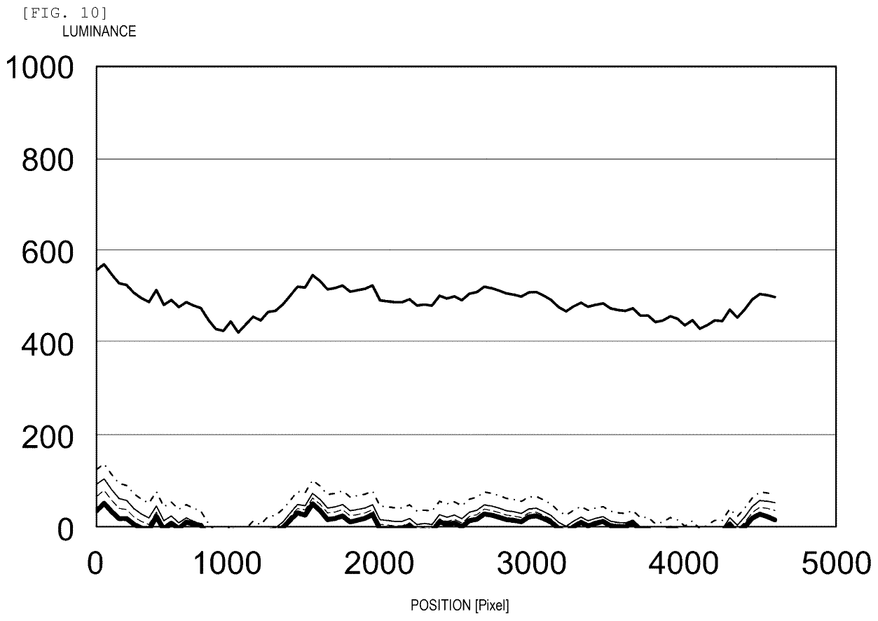

FIG. 10 is a graph showing a pixel luminance along the horizontal direction (first direction) of an image obtained by performing FFT on pixel luminance distribution along the horizontal direction, performing high-pass filter processing, and then performing inverse FFT. A vertical axis of the graph indicates pixel luminance. A solid line at a center of the graph indicates luminance of an original pixel. Each line near 0 indicates pixel luminance after being processed with the high-pass filter at each cut off frequency. An alternate long and short dash line indicates pixel luminance after being processed with a high-pass filter having cut off frequency of spatial frequency 1. A solid line below the alternate long and short dash line is pixel luminance after being processed with the high-pass filter having the cut off frequency of spatial frequency 3, a broken line below the solid line is pixel luminance after being processed with the high-pass filter having the cut off frequency of spatial frequency 5, and next, a thick solid line is pixel luminance after being processed with the high-pass filter having the cut off frequency of spatial frequency 20.

FFT is performed on the pixel luminance distribution along the horizontal direction (first direction) in the image. Thereafter, in order to remove a noise which is a low-frequency component, filtering processing is performed with the high-pass filter in the horizontal direction. A signal intensity of the low-frequency component is reduced by processing with the high-pass filter, resulting in an overall reduction in luminance.

The filtering processing with the high-pass filter in the horizontal direction results in an overall reduction in luminance and a deviation from a value held by an original image, as shown in FIG. 10. Since luminance of the original image shown in FIG. 3 represents the defect density, a shift of the luminance from the original image causes a deviation from a true value of the defect density. In order to compensate for this, filtering processing with the low-pass filter in the vertical direction and adding processing are required.

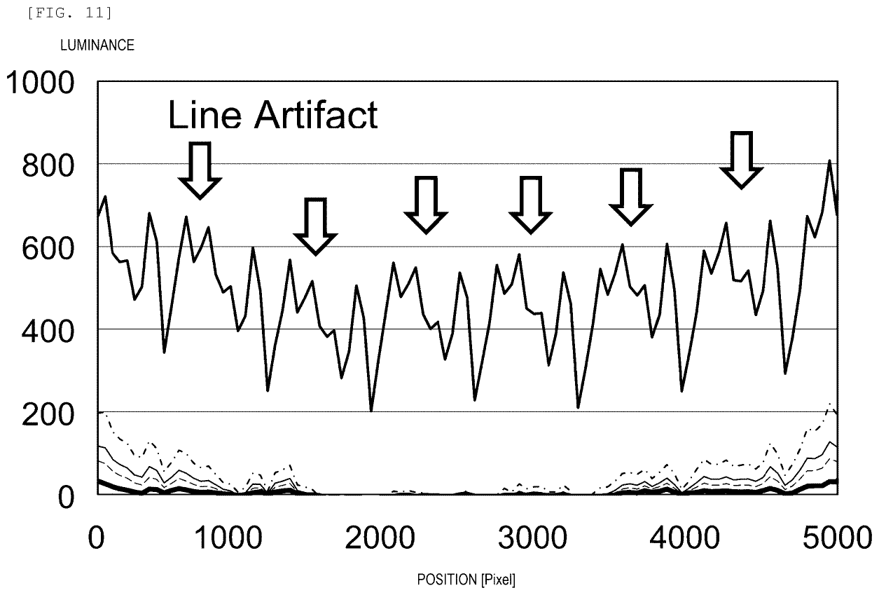

FIG. 11 is a graph showing a pixel luminance along the vertical direction of an image obtained by performing FFT on pixel luminance distribution along the horizontal direction (first direction), performing high-pass filter processing, and then performing inverse FFT. A vertical axis of the graph indicates pixel luminance. A solid line at a center of the graph indicates luminance of an original pixel. Each line near 0 indicates pixel luminance after being processed with the high-pass filter at each cut off frequency. An alternate long and short dash line indicates pixel luminance after being processed with the high-pass filter having cut off frequency of spatial frequency 1. A solid line below the alternate long and short dash line is pixel luminance after being processed with the high-pass filter having the cut off frequency of spatial frequency 3, a broken line below the solid line is pixel luminance after being processed with the high-pass filter having cut off frequency of spatial frequency 5, and next, a thick solid line is pixel luminance after being processed with the high-pass filter having cut off frequency of spatial frequency 20.

By applying the high-pass filter in the horizontal direction, the signal intensity in the low-frequency region can be reduced, and the horizontal stripe noise is reduced as shown in the luminance distribution of FIG. 11. However, by applying the high-pass filter in the horizontal direction, the overall luminance is reduced as shown in the luminance distributions of FIGS. 10 and 11 simultaneously with horizontal stripe noise removal. Since the luminance of the original image of an X-ray topographic image of the SiC wafer represents defect density, and the overall luminance shift causes a deviation from the true value of the defect density. Therefore, it is necessary to compensate for the reduction in luminance.

The luminance was reduced by multiplying a spatial frequency characteristic in the horizontal direction by the high-pass filter to reduce the signal intensity in the low-frequency region. In order to compensate for this, it is necessary to increase the reduced signal intensity in the low-frequency region to the same level as before the reduction. Therefore, the inventors consider compensating for the luminance shift based on a spatial frequency characteristic in the vertical direction which is not a cause of the horizontal stripe noise.

By multiplying the spatial frequency characteristic in the vertical direction by the low-pass filter, it is possible to reduce the signal intensity in the high-frequency region while maintaining the signal intensity in the low-frequency region. Thus, by combining the high-pass filter in the horizontal direction and the low-pass filter in the vertical direction, the luminance shift can be reduced while removing the horizontal stripe noise.

Therefore, the inventors apply the high-pass filter in the horizontal direction, apply a low-pass filter in the vertical direction separately from the high-pass filter, and then perform summation.

After the application of the high-pass filter in the horizontal direction, the horizontal stripe noise can be removed, but the overall luminance is reduced. After the low-pass filter is applied in the vertical direction, the signal intensity in the low-frequency region is maintained, so that the luminance is not shifted from that before the filter is applied. By adding the luminance after application of the high-pass filter in the horizontal direction and the luminance after application of the low-pass filter in the vertical direction, the luminance becomes equivalent to the luminance of the original image, and the luminance shift can be compensated.

At this time, a sum of filter characteristics (transmittance) of the high-pass filter and the low-pass filter at each spatial frequency needs to be 1.

Here, the inventors confirm that a horizontal stripe disappears in the high-pass filter in which the spatial frequency is 5 to 20 as the cut off frequency. The horizontal stripe disappears at spatial frequency of 20 or more, but signals other than the horizontal stripe noise are also filtered. Thus, a high-pass filter having the cut off frequency of the spatial frequency 5 t to 20 is desirable. That is, it is preferable to set the cut off period to ⅕ to 1/20 of the wafer diameter L [Pixel].

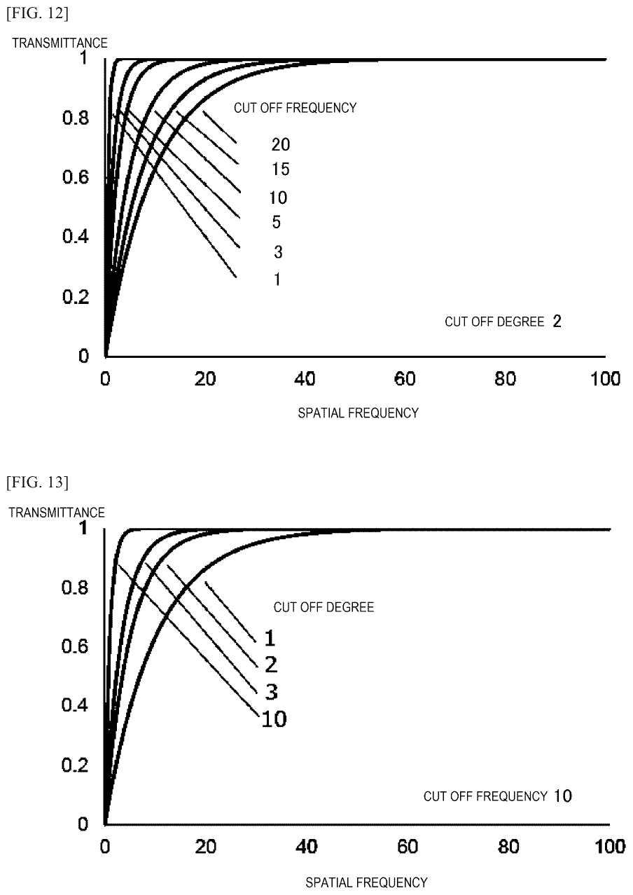

FIG. 12 is a graph showing dependence of filter characteristics of the high-pass filter on the cut off frequency.

A vertical axis of the graph indicates transmittance of the high-pass filter. A horizontal axis of the graph indicates spatial frequency. As shown in this graph, the image processing device 1 can set the filter characteristic so as to reduce a desired low-frequency component by fixing the cut off degree to 2 and changing the cut off frequency.

FIG. 13 is a graph showing dependence of filter characteristics on a cut off degree. A vertical axis of the graph indicates transmittance of the high-pass filter. A horizontal axis of the graph indicates spatial frequency. As shown in this graph, the image processing device 1 can set the filter characteristic so as to reduce a desired low-frequency component by fixing the cut off frequency to spatial frequency 10 and changing the cut off degree. The cut off degree is preferably about 2 to 10.

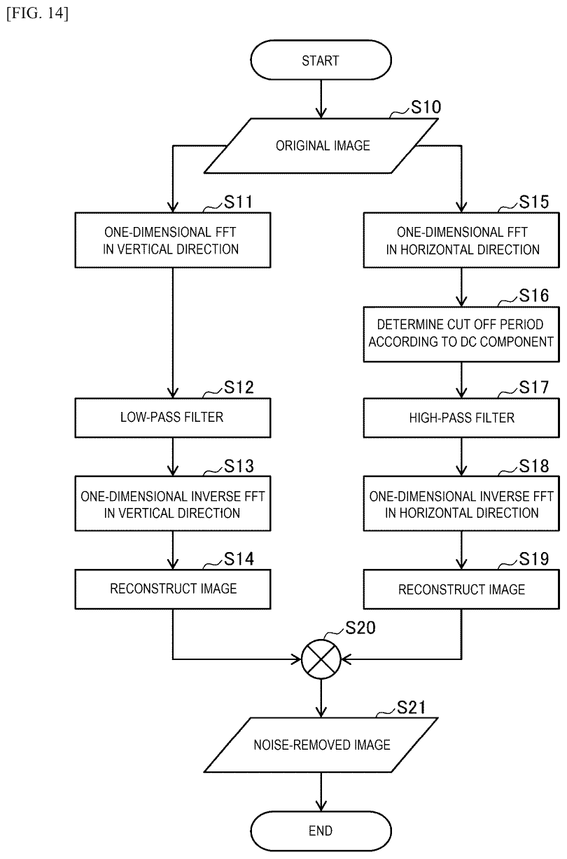

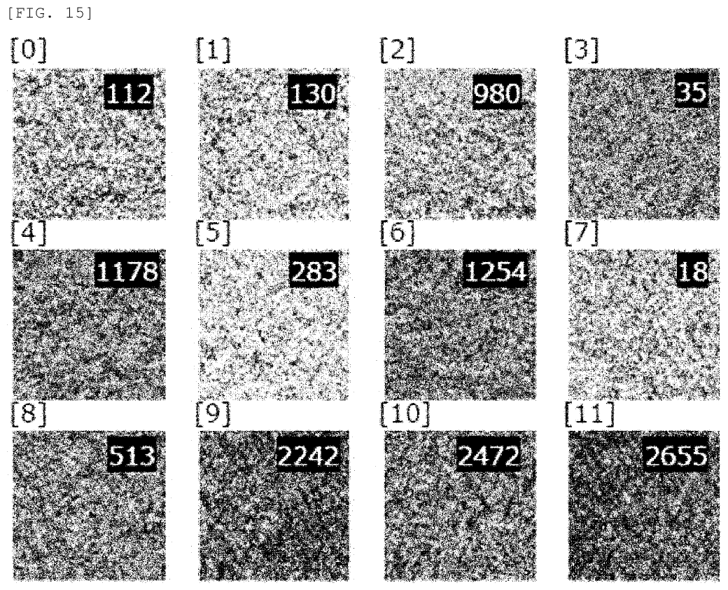

FIG. 14 is a flowchart showing noise removal processing.

When an original image is input (S10), the CPU 11 of the image processing device 1 starts the noise removal processing. When a filtering condition is determined (S16) in advance, the processing proceeds from step S10 to steps S11 and S15, but any one of processing of steps S11 to S14 and processing of steps S15 to S19 may be executed first, or may be executed in parallel.

The high-pass filter unit 21 performs one-dimensional FFT in a horizontal direction (S15) to obtain a spectrum. The filter setting unit 24 specifies a range of spatial frequency in which a low-frequency component of the spectrum exceeds a predetermined value, and sets the range as cut off frequency in the high-pass filter unit 21 and the low-pass filter unit 22 (S16). If a period of a horizontal stripe noise is understood in advance, the filter setting unit 24 does not need to perform the processing of step S16.

Thereafter, the high-pass filter unit 21 applies a high-pass filter to a result of the FFT (S17), performs one-dimensional inverse FFT in the horizontal direction (S18), and reconstructs the image (S19). The low-pass filter unit 22 performs one-dimensional FFT in a vertical direction (S11), applies a low-pass filter (S12), performs one-dimensional inverse FFT in the vertical direction (S13), and reconstructs the image (S14).

An order of processing of steps S12 to S14 of the processing of low-pass filter unit 22 and processing of steps S15, and S17 to S19 of the processing of the high-pass filter unit 21 is not limited, and either may be executed first, or both may be executed in parallel.

The addition unit 23 adds an image processed by the low-pass filter unit 22 and an image processed by the high-pass filter unit 21 (S20). Accordingly, when the noise-removed image is generated (S21), the processing of FIG. 14 ends.

The horizontal stripe noise of the image of the wafer 9 is a low-frequency component having directionality in the first direction (horizontal). Therefore, the image processing device 1 applies the high-pass filter in the first direction (horizontal) to remove a noise which is a low-frequency component. Since the overall luminance of the image after applying the filter and performing the inverse FFT is shifted from the true value only with the high-pass filter, the low-pass filter is applied in the second direction (vertical) perpendicular to the first direction to compensate for the luminance shift. At this time, a sum of transmittances (filter characteristics) of the high-pass filter and the low-pass filter is 1.

Accordingly, a noise can be removed from an image obtained by roughly imaging the wafer 9.

### <<Creation of Model for Multiple Regression Analysis>>

The image processing device 1 cuts out each region to be analyzed with high precision from a noise-removed image. The image processing device 1 calculates pixel information (a sum, average, median value, histogram, and the like of luminance) for these region, and creates a multiple regression analysis model based on defect density obtained by a high-precision analysis. By using the multiple regression analysis model, a defect density distribution in the entire wafer can be predicted based on a noise-removed image of the wafer.

FIG. 15 is a diagram showing an example of each region cut out from a noise-removed image and defect density thereof.

The image processing device 1 cuts out a region from an image obtained by rough imaging and removing a noise, and calculates defect density in each region by a high-precision analysis. Numerical values shown at an upper right of each region indicate defect density obtained by the high-precision analysis. [0] to [11] shown at an upper left of the regions are identification numbers of the regions.

FIG. 16 is a diagram showing a luminance histogram of each region cut out from the noise-removed image (the image shown in FIG. 15).

Here, the luminance histogram is calculated as the pixel information, but the invention is not limited thereto, and a sum, an average, a median value, or the like of luminance of pixels may be calculated.

In this manner, the image processing device 1 creates a multiple regression analysis model in which the pixel information of each region (including a height, an average value, a median value, a standard deviation, and the like of the luminance histogram) is set as the explanatory variable and the defect density obtained by the high-precision analysis of each region is set as the objective variable. A single regression analysis predicts one objective variable with one explanatory variable, while a multiple regression analysis predicts one objective variable with a plurality of explanatory variables.

A value 0.94 was obtained by investigating a correlation coefficient between a predicted value based on a multiple regression model and a correct value. That is, by using a model for the multiple regression analysis, the defect density distribution of the entire wafer can be predicted in a short time and with high precision.

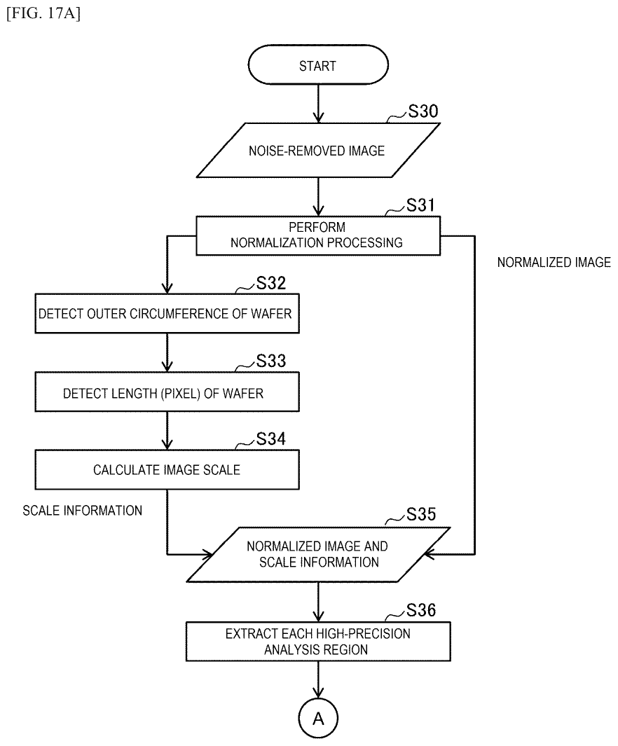

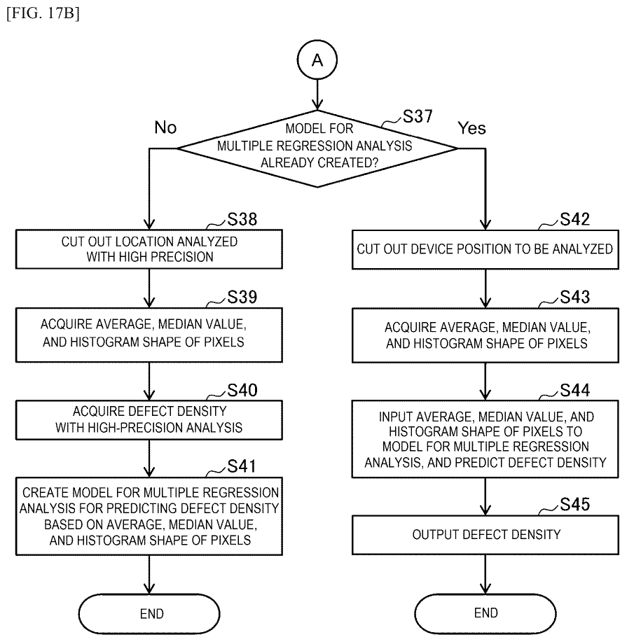

FIGS. 17A and 17B are flowcharts of estimating defect density based on a noise-removed image.

When a noise-removed image is generated in the image processing device 1 (S30), defect density estimation processing is started.

First, the normalization processing unit 26 normalizes luminance possessed by the noise-removed image (S31). By normalizing the luminance in the image, the normalization processing unit 26 can compare images related to different wafers. When an outer circumference of the wafer is detected (S32), the image scale calculation unit 27 detects a length of the wafer (S33) and calculates an image scale (S34). By using the image scale, in step S35, the analysis region extraction unit 28 can specify a position and size of the wafer captured in the image.

When each high-precision analysis region is extracted from a normalized image (S36), the analysis region extraction unit 28 proceeds to FIG. 17B and determines whether a model for the multiple regression analysis is already created (S37). If the model for the multiple regression analysis is not created (No), the analysis region extraction unit 28 proceeds to step S38. If the model for the multiple regression analysis is already created (Yes), the analysis region extraction unit 28 proceeds to step S42.

In step S38, the analysis region extraction unit 28 cuts out a high-precision analysis region (S38). Next, the pixel information calculation unit 25 calculates pixel information such as an average, a median value, and a histogram shape of pixels in this region (S39). The high-precision analysis unit 29 analyzes this region with high precision and obtains defect density (S40). The multiple regression analysis model creation unit 30 creates a model for the multiple regression analysis for predicting the defect density based on the average, the median value, the histogram shape, and the like of the pixels (S41), and after storing the model in the multiple regression analysis model database 32, ends the processing related to creation of the model for the multiple regression analysis.

In step S42, the analysis region extraction unit 28 cuts out an analysis region (device position). Next, the pixel information calculation unit 25 calculates pixel information such as an average, a median value, and a histogram shape of the pixels in this region (S43). The defect density prediction unit 31 inputs pixel information such as an average, a median value, and a histogram shape of the pixels in each region to a model for the multiple regression analysis, predicts the defect density of each region (S44), and outputs a predicted defect density distribution to the display unit 14 or the like (S45), and ends prediction processing of the defect density distribution.

### (Modification)

The invention is not limited to the above-described embodiment, and includes various modifications. For example, the embodiment described above has been described in detail for easy understanding of the invention, and the invention is not necessarily limited to those including all the configurations described above. A part of a configuration according to one embodiment can be replaced with a configuration according to another embodiment, and the configuration according to another embodiment can be added to the configuration according to one embodiment. A part of the configuration of each embodiment also could be added, deleted, or replaced with other configurations.

A part or all of the above configurations, functions, processing units, processing methods, or the like may be implemented by hardware such as an integrated circuit. The above configurations, functions, or the like may also be implemented by software by a processor interpreting and executing a program to implement respective functions. Information such as a program, a table, and a file for implementing each function can be stored in a recording device such as a memory, a hard disk, or a solid state drive (SSD), or in a recording medium such as a flash memory card or a digital versatile disk (DVD).

In the embodiments, a control line or an information line shows those which are considered necessary for the description, and does not necessarily show all control lines or information lines on a product. It may be considered that almost all the configurations are actually coupled to one another.

Modifications of the invention include, for example, the following (a) to (c).
(a) The invention is not limited to a defect analysis of the SiC wafer. The invention can be applied to any noise having directionality occurred when a line-scanned image is formed. For example, the invention may be applied to noise removal for an image in which a horizontal stripe is generated by a scanning electron microscope (SEM) or an atomic force microscope (AFM).
(b) Although noise removal for an image having a noise in the horizontal direction is described in the above embodiment, the invention may be applied to an image having a noise in the vertical direction.
(c) The invention is not limited to the noise having directionality occurred when a line-scanned image is formed, and may be applied to removal of a noise having directionality due to any cause.

### REFERENCE SIGNS LIST

1: image processing device
11: CPU
12: ROM
13: RAM
14: display unit
15 communication unit
16: operation unit
18: storage unit
181: image processing program
21: high-pass filter unit
22: low-pass filter unit
23: addition unit
24, 24-2, 24-3: filter setting unit
25 pixel information calculation unit
26: normalization processing unit
27: image scale calculation unit
28: analysis region extraction unit
29: high-precision analysis unit
30 multiple regression analysis model creation unit
31: defect density prediction unit
32: multiple regression analysis model database
41: X-ray light source
42: detector
43: X-ray irradiation region
9: wafer
91: region
92: defect

1. An image processing device comprising:
a high-pass filter unit configured to perform filtering processing on an image containing a noise having directionality in a first direction with a high-pass filter in the first direction;
a low-pass filter unit configured to perform filtering processing on the image in a second direction perpendicular to the first direction with a low-pass filter; and
an addition unit configured to add an image processed by the high-pass filter unit and an image processed by the low-pass filter unit.

2. The image processing device according to claim 1, wherein
a sum of transmittance at each spatial frequency of the high-pass filter unit and transmittance at each spatial frequency of the low-pass filter unit is I.

3. The image processing device according to claim 1, further comprising:
a filter setting unit configured to change a cut off period in the low-pass filter unit and the high-pass filter unit according to a period of a noise in the image having directionality in the first direction.

4. The image processing device according to claim 3, wherein
the cut off period of the low-pass filter unit and the high-pass filter unit is ⅕to 1/20of a length L of the image in the first direction.

5. The image processing device according to claim 1, further comprising:
a defect density prediction unit configured to predict a defect density distribution in an image based on pixel information of a noise-removed image added by the addition unit.

6. The image processing device according to claim 5, wherein
the pixel information includes any one of a height, an average value, a median value, and a standard deviation of a luminance histogram in any region.

7. An image processing method comprising:
executing a step of calculating an image filtered individually with a high-pass filter in a first direction for each image containing a noise having directionality in the first direction;
executing a step of calculating an image filtered with a low-pass filter in a second direction perpendicular to the first direction; and
executing a step of adding an image filtered with the high-pass filter and an image filtered with the low-pass filter.

8. The image processing method according to claim 7, wherein
the step of calculating an image filtered with the high-pass filter in the first direction and the step of calculating an image filtered with the low-pass filter in the second direction for an image containing a noise having directionality in the first direction are executed in either order.

9. An image processing program for causing a computer to execute
a procedure of performing filtering processing on an image containing a noise having directionality in a first direction with a high-pass filter in the first direction,
a procedure of performing filtering processing on the image in a second direction perpendicular to the first direction with a loin-pass filter, and
a procedure of adding an image filtered with the high-pass filter and an image filtered with the low-pass filter.
